(19) United States
(12) Patent Application Publication
(10) Pub. No.: US 2026/0229045 A1
(43) Pub. Date: Aug. 6, 2026

(54) VEHICULAR OCCUPANT MONITORING SYSTEM WITH EXTERIOR OBJECT DETECTION

(71) Applicant: Magna Electronics Inc., Auburn Hills, MI (US)

(72) Inventor: Bishnu Raveendran, Rochester, MI (US)

(21) Appl. No.: 19/457,374

(22) Filed: Jan. 23, 2026

Related U.S. Application Data
(60) Provisional application No. 63/749,841, filed on Jan. 27, 2025.

(51) Int. Cl. G06V 20/59; B60R 1/04; B60R 1/12; B60W 50/00; B60W 50/14; G06V 20/58; G06V 40/10

(52) U.S. Cl. CPC G06V 20/59; B60R 1/04; B60R 1/12; B60W 50/0098; B60W 50/14; G06V 20/58; G06V 40/10; B60R 2001/1253; B60W 2050/143; B60W 2050/146; B60W 2420/403; B60W 2420/408; B60W 2420/54; B60W 2554/4044

(57) ABSTRACT

A vehicular cabin monitoring system includes an interior sensor disposed at an interior portion of an interior cabin of a vehicle and sensing within the interior cabin and an exterior sensor sensing exterior of the vehicle. Via processing sensor data captured by the interior sensor, the system detects a body part of an occupant of the vehicle proximate an opened window of the vehicle. Responsive to detection of the body part proximate the opened window, and via processing of sensor data captured by the exterior sensor, the system determines that an object exterior the vehicle is hazardous to the body part proximate the opened window. Responsive to determination that the object exterior the vehicle is hazardous to the body part proximate the opened window, the system generates an alert to the occupant of the vehicle and/or controls movement of the window toward a closed position.

### CROSS REFERENCE TO RELATED APPLICATION

The present application claims the filing benefits of U.S. provisional application Ser. No. 63/749,841, filed January 27, 2025, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A cabin monitoring system for a vehicle includes an interior sensor disposed at an interior portion of an interior cabin of a vehicle, such as a driver monitoring camera disposed at an interior rearview mirror assembly of the vehicle, a radar sensor, and/or a beam break sensor. The system includes an exterior sensor, such as one or more cameras, one or more radar sensors, and/or one or more ultrasonic sensors, disposed at the vehicle and sensing exterior of the vehicle. Sensor data captured by the interior sensor is transferred to an electronic control unit (ECU) and sensor data captured by the exterior sensor is transferred to the ECU. The ECU includes electronic circuitry and associated software, and the electronic circuitry of the ECU includes a processor operable to process sensor data transferred to the ECU. Via processing at the ECU of sensor data captured by the interior sensor, the vehicular cabin monitoring system detects a body part of an occupant of the vehicle at or near an opened window of the vehicle. Responsive to detection of the body part of the occupant at or near the opened window of the vehicle, and via processing at the ECU of sensor data captured by the exterior sensor, the vehicular cabin monitoring system determines that an object exterior the vehicle is hazardous to the body part of the occupant at or near the opened window of the vehicle. Responsive to determination that the object exterior the vehicle is hazardous to the body part of the occupant at or near the opened window of the vehicle, the vehicular cabin monitoring system performs at least one of (i) generates an alert to the occupant of the vehicle and (ii) moves the window toward a closed position.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of an interior rearview mirror assembly having a cabin monitoring camera and a near infrared light emitter behind a reflective element of the interior rearview mirror assembly;

FIG. 3 is another perspective view of the interior rearview mirror assembly, showing the cabin monitoring camera and light emitters without the reflective element;

FIGS. 4-6 are schematic diagrams of the occupant monitoring system that detects hazards related to an opened window of the vehicle based on sensor data representative of the interior cabin of the vehicle and based on sensor data representative of regions exterior of the vehicle;

FIG. 7 is a schematic diagram of the occupant monitoring system configured to determine a position of a body part of an occupant of the vehicle relative to the opened window of the vehicle;

FIG. 8 is a schematic diagram of the occupant monitoring system configured to determine a projected trajectory of an object exterior the vehicle relative to the opened window of the vehicle; and

FIG. 9 is a flowchart of an example method of operations for detecting hazards related to the opened window of the vehicle.

### DESCRIPTION OF THE PREFERRED EMBODIMENTS

A vehicle vision system and/or driver or driving assist system and/or object detection system and/or alert system operates to capture image and sensor data exterior of the vehicle and may process the captured data to display images and to detect objects at or near the vehicle and in the predicted path of the vehicle, such as to assist a driver of the vehicle in maneuvering the vehicle in a rearward direction. The vision system includes an image processor or image processing system and data processor or data processing system that is operable to receive image data from one or more cameras and sensor data from one or more sensors and provide an output, such as to a display device for displaying images representative of the captured image data. Optionally, the vision system may provide display, such as a rearview display or a top down or bird's eye or surround view display or the like.

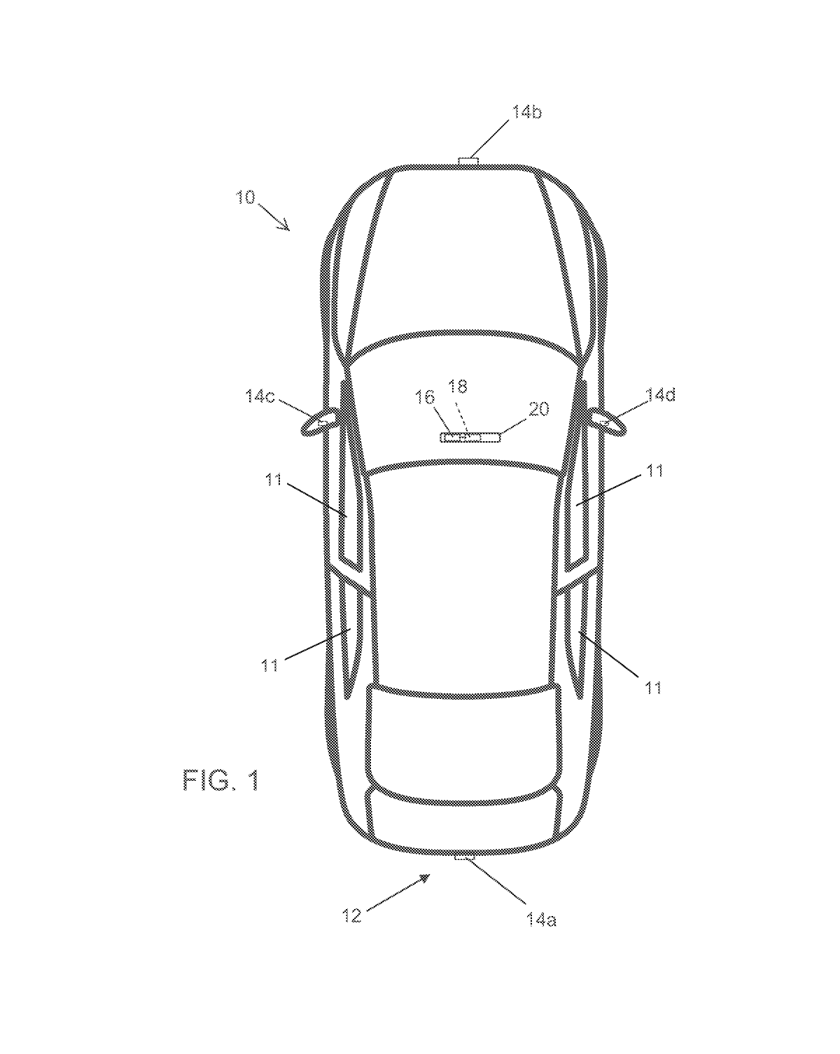

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

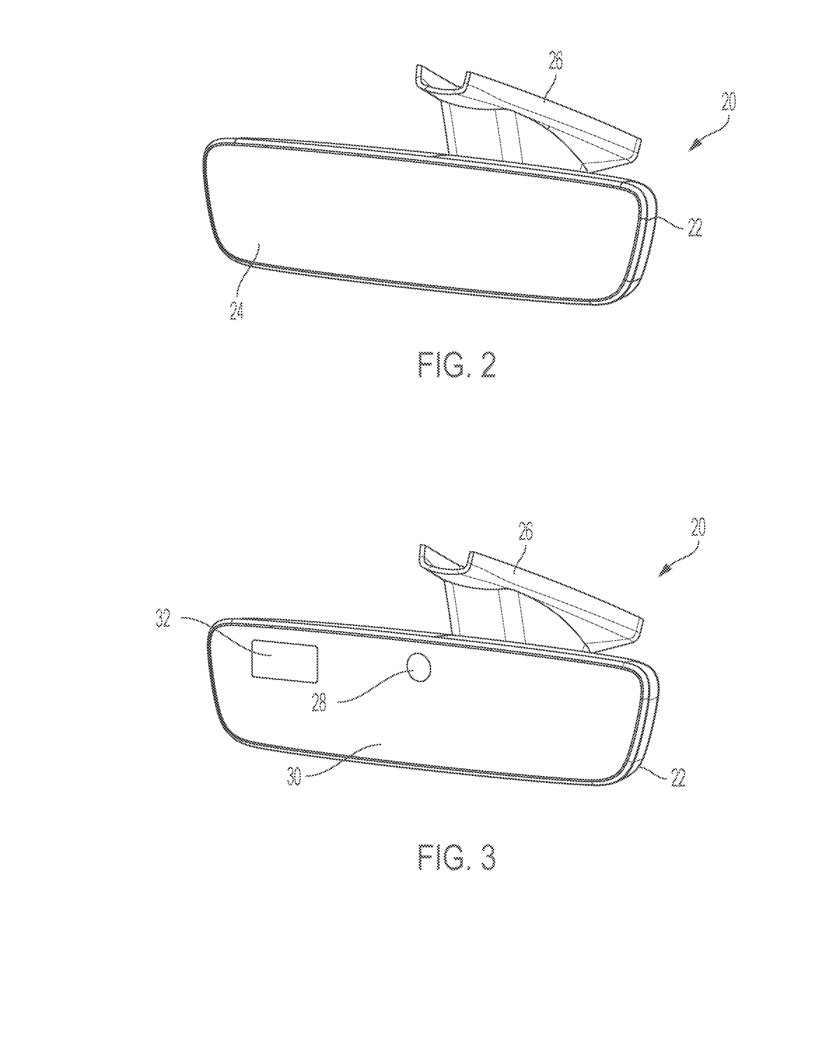

Further, the interior rearview mirror assembly 20 for the vehicle 10 includes a casing 22 and a reflective element 24 positioned at a front portion of the casing 22 (FIG. 2). In the illustrated embodiment, the mirror assembly 20 is configured to be adjustably mounted to an interior portion of the vehicle 10 (such as to an interior or in-cabin surface of a vehicle windshield or a headliner of the vehicle or the like) via a mounting structure or mounting configuration or assembly or stay 26. The mirror assembly 20 includes or is associated with a driver monitoring system (DMS) or occupant monitoring system (OMS) 13 and the system 13 includes a camera 28 disposed at and movable with the mirror head. For example, the camera 28 may be disposed behind the mirror reflective element 24 and view through the mirror reflective element 24 for capturing image data representative of the interior cabin of the vehicle, including the driver's head region and occupant region of the vehicle cabin. The system 13 may utilize aspects of driver monitoring systems or occupant monitoring systems described in U.S. Pat. Nos. 11,930,264; 11,827,153; 11,780,372 and/or 11,639,134, and/or International Publication No. WO 2023/220222 and/or International Patent Application Ser. No. PCT/US25/038021, filed Jul. 17, 2025 (Attorney Docket DON01 FP5398WO), which are all hereby incorporated herein by reference in their entireties.

The mirror assembly 20 includes or is associated with the DMS, the OMS, and/or a cabin monitoring system 13, with the mirror assembly 20 including the driver/occupant monitoring camera 28 disposed at a back plate 30 (and viewing through an aperture of the back plate) behind the reflective element 24 and viewing through the reflective element 24 toward at least a head region of the driver of the vehicle 10 (FIG. 3). That is, the driver monitoring camera 28 is accommodated by the mirror head, and with the mounting structure 26 attached at the interior portion of the cabin of the vehicle 10, the driver monitoring camera views within the cabin of the vehicle 10 toward at least the head region of the driver. The DMS 13 may include an infrared light (IR light) or near infrared light (near IR light) emitter 32 disposed at the back plate and emitting IR light or near IR light that passes through another aperture of the back plate and through the reflective element 24.

Image data captured by the DMS/OMS camera 28 may be transferred to the ECU 18 for processing image data captured by the DMS/OMS camera 28. Although shown in FIG. 1 as disposed at the mirror assembly 20, the ECU 18 may be disposed remote from the mirror assembly 20 (e.g., a vehicle domain controller) and image data may be transferred from the DMS/OMS camera 28 to the remote ECU, such as via a coaxial cable. The image data captured by the camera 28 may be processed at the ECU 18 for DMS and/or OMS functions, such as for a head and face direction and position tracking system and/or eye tracking system and/or gesture recognition system. Moreover, the captured image data may be processed (e.g., at the ECU 18) to determine if a body part (e.g., an arm, a hand, a head, a leg or foot, and the like) of the driver and/or a passenger of the vehicle 10 is exposed through an open window of the vehicle 10. Optionally, the DMS/OMS camera may be disposed at other portions of the interior cabin of the vehicle, such as at a windshield-mounted electronics module (WEM), at the mounting structure 26 of the mirror assembly 20, at the headliner of the vehicle, and the like, where the mounting position of the camera allows the camera to view the driver and/or one or more passengers of the vehicle and at least a portion of a window or door region of the vehicle 10.

That is, the system may process sensor data from one or more sensors sensing portions or regions of the interior cabin of the vehicle (e.g., including the DMS/OMS camera 28) to monitor the driver and passengers of the vehicle to determine whether a body part of one or more of the vehicle occupants is disposed at or near or extending through a window 11 of the vehicle 10. Further, the system may process sensor data from one or more sensors sensing exterior of the vehicle (e.g., including the cameras of the vehicular vision system 12) to detect objects, pedestrians, and/or other vehicles that may come near or in contact with the vehicle and/or occupant's body part extending through the window 11. Based on determining that a body part of one or more of the vehicle occupants is disposed at or near or extending through the window 11 and responsive to determining a potential collision or hazard to the driver or passenger from an object exterior the vehicle, the system generates an alert and/or actuates a safety measure. For example, the system may generate an audible alert and/or visual alert within the cabin of the vehicle and/or at least partially raise or close the opened window 11. The system may be configured to monitor position of the driver and passengers of the vehicle relative to each window 11 of the vehicle 10, including front driver-side and passenger-side windows, rear driver-side and passenger-side windows, a liftgate window, a sunroof or moonroof or panoramic glass roof, and the like.

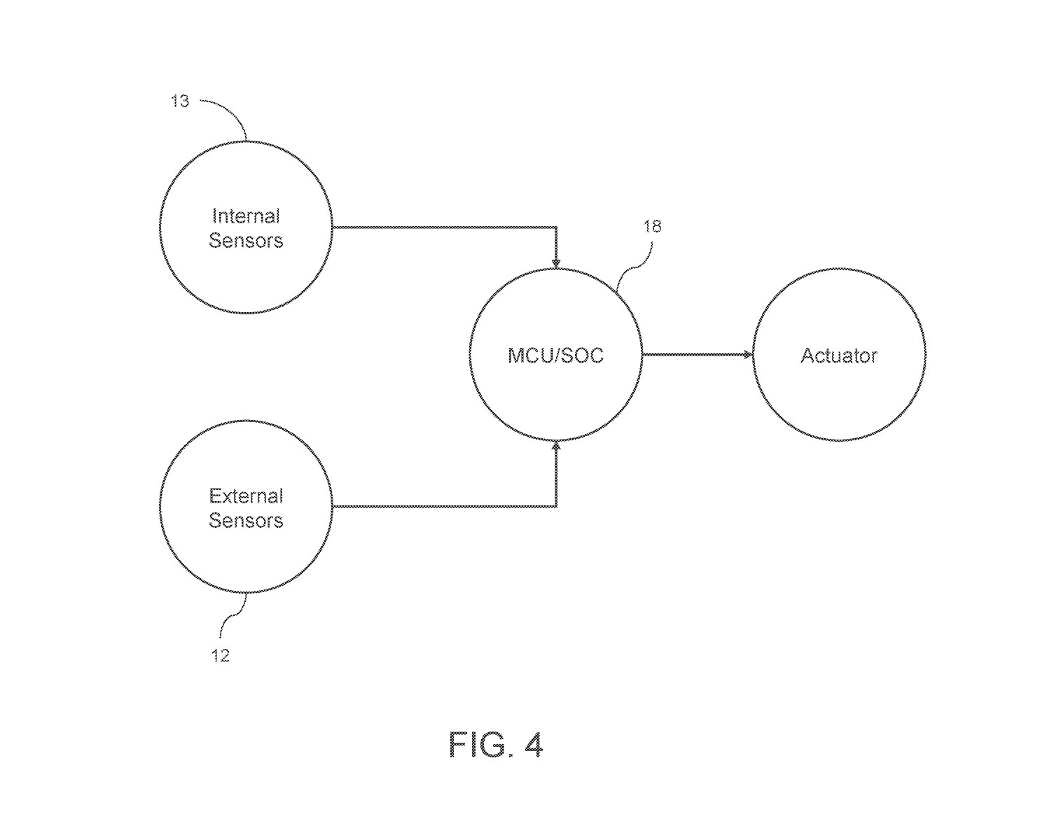

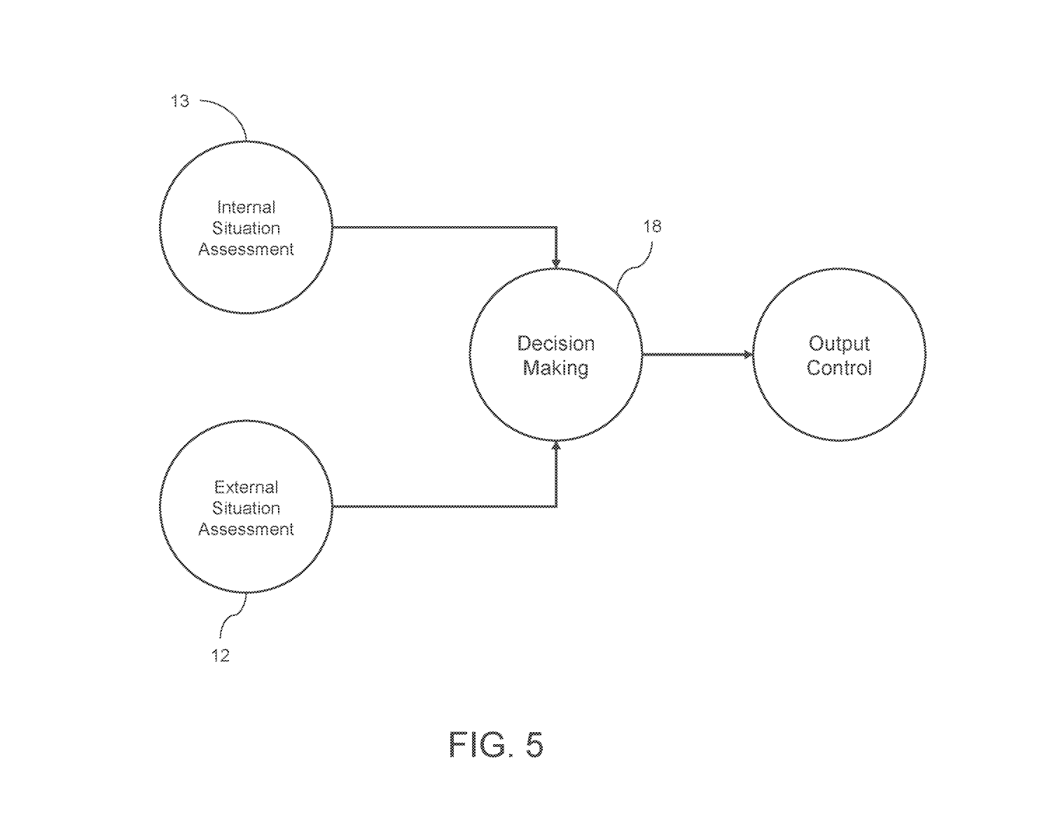

Referring to FIGS. 4-6, the vehicular vision system 12 and/or one or more external sensors may transfer sensor data representative of objects and the environment exterior the vehicle 10 to the ECU 18 and the DMS/OMS 13 and/or one or more internal sensors may transfer sensor data representative of objects and passengers within the interior cabin of the vehicle 10 to the ECU 18. Optionally, the vehicular vision system 12 may process the captured sensor data to perform the external situation assessment and generate a signal to the central ECU 18 indicating the presence or absence of an external threat (e.g., an object or other vehicle approaching close to an opened window), and the DMS/OMS 13 may process the captured sensor data to perform the internal situation assessment and generate a signal to the central ECU 18 indicating the presence or absence of an internal threat (e.g., a body part extending through the opened window). Based on the external situation assessment and the internal situation assessment, the system may determine that the driver or passenger is in a hazardous position (e.g., with a body part at or near or extending through the window) and determine presence of a potential collision or hazard and generate the output to alert the driver or passenger and/or actuate the safety measure.

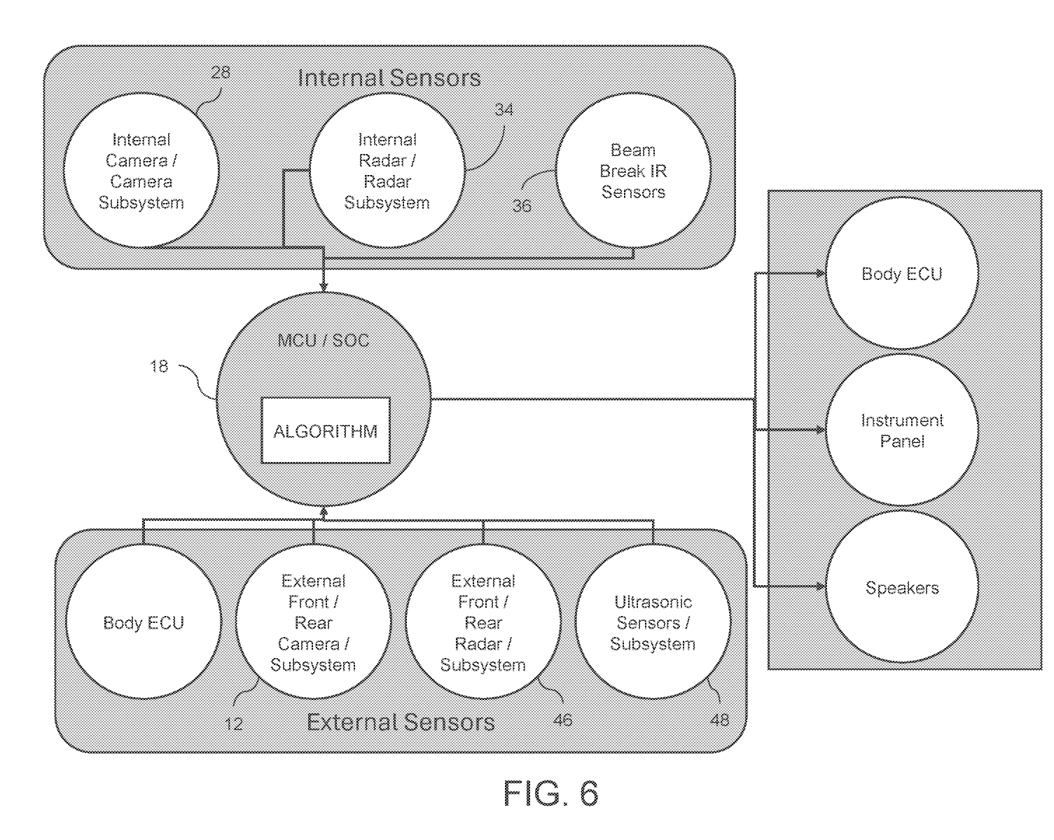

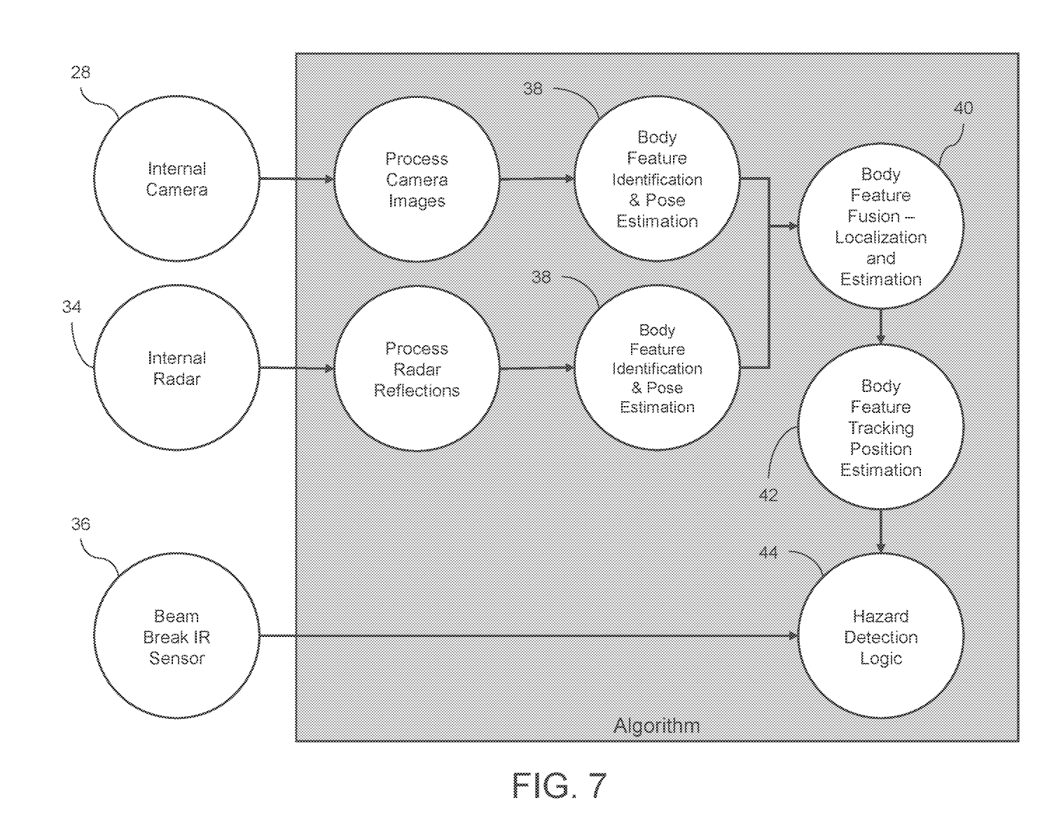

As shown in FIGS. 6 and 7, the system may process sensor data captured by the DMS/OMS camera 28, one or more interior radar sensors 34 sensing regions within the interior cabin of the vehicle, and/or one or more near IR or IR beam break sensors 36 at or near the windows 11. That is, to detect if a vehicle occupant is putting any part of their body outside the window 11, the system may use internal radar sensors, internal cameras, and/or a beam break sensor at the window. The internal camera may provide a raw image, which may be processed by a neural network 38 for pose estimation and feature identification, such as to determine the head, hands, and fingers of the occupant, to determine their position within the vehicle. The camera may include a thermal camera. The position within the vehicle may also be determined by one or more radar sensors, such as an internal rear-facing radar. The raw radar sensor data may be processed by the neural network 38 for pose estimation and feature identification. Sensor data and/or identified features from the radar sensor data and/or the image data may be combined using a sensor fusion module 40 to increase data reliability. For example, the image data and radar sensor data may be processed to determine a type of body part (e.g., an arm, a hand, a head, and the like) and its relative to position to the window 11. These determinations may be combined and/or synchronized to produce a more accurate determination of the body part and its position relative to the window. Further, a body feature tracking position estimation module 42 may track the body part as it moves relative to the window 11. The position of the body part relative to the window 11 may be tracked by hazard detection logic 44 to determine whether the body part is in a hazardous position (e.g., when extended through the window and/or when disposed near an opened window).

Additionally, the IR beam break sensors 36 may be attached across the opening of the window 11. These sensors 36 include an IR beam producer and a receiver and may include a plurality of IR beam emitters and/or a plurality of beam receivers. The IR beam producer may emit an IR beam that extends across the opening of the window 11 to be detected by a corresponding beam receiver and if the IR beam is interrupted by an object, the sensor will trigger and transmit a signal to the hazard detection logic 44. This provides a simpler solution compared to the more complex camera/radar systems. The hazard detection logic 44 may combine data from all the different internal sensors to determine if a hazardous scenario exists.

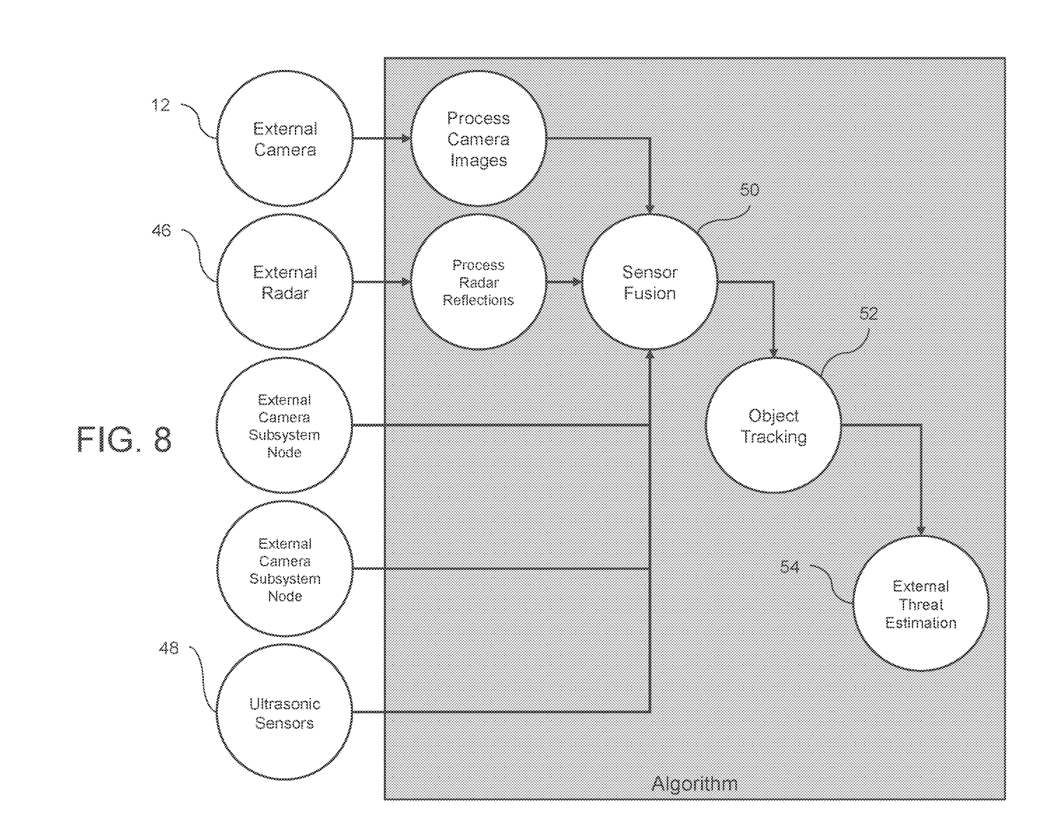

Referring to FIGS. 6 and 8, the system may process sensor data captured by the one or more exterior viewing cameras of the vehicular vision system 12, one or more exterior radar sensors 46 sensing regions exterior of the vehicle 10, and/or one or more ultrasonic sensors 48 sensing regions exterior of the vehicle 10. The system may process raw image data from the cameras and/or raw radar sensor data from the radar sensors 46 to detect potential hazardous objects exterior the vehicle. Optionally, the image data and radar sensor data may be processed by the respective camera system or radar system and the hazard detection logic may receive determination of the potential hazardous object from the camera system or radar system. In other words, the radar/camera inputs may be in the form of images or externally processed at their edge nodes. A sensor fusion module 50 may combine inputs from the cameras, radar sensors 46 and/or ultrasonic sensors 48 to determine presence and position of hazardous objects exterior the vehicle. The external object may be identified in two-dimensional or three-dimensional coordinates and a projected path or trajectory of the object is tracked via an object tracking module 52. The object tracking module 52 may project an estimated path for the detected object's motion and an external threat estimation module 54 may determine if the object is a threat based on whether the object is going to pass close to the vehicle 10, close to the opened window 11 and/or collide with the vehicle 10.

Examples of external threats include pedestrians, such as people walking or running near the vehicle 10, especially if the pedestrian suddenly changes direction or speed. Further, an external threat may be a cyclist, such as bicycles moving alongside or crossing the vehicle's path. The external threat may include other objects, such as cars, trucks, motorcycles and the like that may be merging lanes or stopping abruptly. Further, the external threat may include stationary objects, such as parked vehicles, barriers, and debris in the road. The system may classify the hazardous object for determining whether to generate the alert to the driver. For example, a stationary object (e.g., a barrier or tree branch) estimated to pass near an opened window may be more readily noticeable to the driver of the vehicle than an approaching vehicle estimated to pass near the opened window, and thus the system may generate the alert and/or actuate the safety measure responsive to determining an approaching vehicle but not for an approaching stationary object.

Responsive to determining that an object exterior the vehicle presents a hazard to the driver or passenger of the vehicle through the opened window 11 of the vehicle 10, the system may generate an alert to the driver and/or passenger. For example, the system may generate a visual alert within the vehicle (e.g., a warning message at an infotainment screen, an illuminated icon at the gauge cluster or instrument panel, and the like) or the system may trigger an audible alert (e.g., a warning message or a tone or chime played at speakers of the vehicle).

Optionally, the system may operate the window of the vehicle to move from the opened position toward the closed position. This may cause the driver or passenger to pull their body part within the vehicle and/or the moving window 11 may push the body part into the cabin of the vehicle. The system may operate the window based on the determined body part. For example, the system may operate the window to move toward the closed position based on determination that a limb is within the opened window and the system may not operate the window based on determination that a head or neck is within the opened window. Further, the system may operate the window to move toward the closed position without pinching or closing the body part of the occupant within the window. That is, with window 11 moving toward the closed position, and in response to determining that the body part of the occupant is still extending through the window opening, the system may stop moving the window 11 toward the closed position and may move the window 11 back toward the opened position.

In some examples, the system may detect a person exterior the vehicle with a body part extending through the opened window, such as when the vehicle is parked. Based on determination that a person exterior the vehicle has a body part extending through the window and responsive to the closure mechanism of the window 11 being activated (e.g., an autoclose feature), the system may stop movement of the window toward the closed position and/or generate an alert. In other examples, the system may determine the person outside the vehicle with the body part extending through the window and operate the window 11 to move toward the closed position, such as to provide an anti- theft feature. For example, the system may operate the window toward the closed position based on not determining presence of a keyfob associated with the vehicle, and the system may not operate the window toward the closed position based on determining presence of the keyfob.

In other words, once a hazardous situation is identified, actions may include sending a warning chime to the speaker, displaying a visual warning on the instrument panel, deactivating the auto-close feature to prevent a hazard if the auto-close feature is activated and a person is putting their head from outside to inside the vehicle. In cases where the person is inside the vehicle and the threat is from outside, the window may be partially raised in a controlled manner to push the person's body part inside the vehicle. For example, if the driver has their elbow resting on the car window and there is an immediate threat, raising the window will push their hand inside the car. However, this mechanism may not work if the chin of the driver is outside. If only the head is slanting outside, raising the window may be sufficient to prevent the hazard. The output control is managed via input from the camera/radar, providing feedback on the person's position relative to the window, and is a closed-loop control function to effectively push the body part inside by raising the window in a controlled manner. Alternatively, even if there is no threat, the system may still provide feedback to a responsible driver about the hazard and ask the driver (usually a parent) to take necessary action.

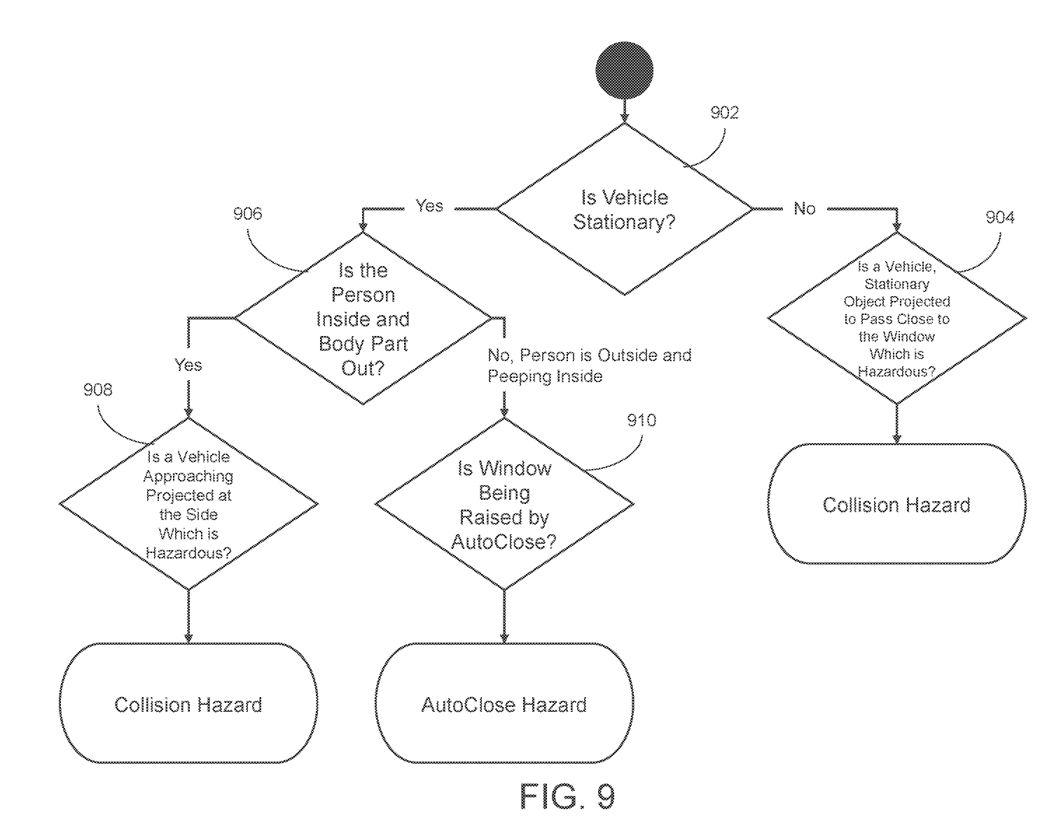

FIG. 9 is an example flowchart of operations of a method 900 for detecting a hazard caused by a body part through an opened window of the vehicle. At operation 902, the method 900 includes determining whether the vehicle 10 is stationary. Based on determination that the vehicle is not stationary, the method 900 includes at operation 904 determining whether an object exterior the vehicle is projected to pass close to an opened window 11 of the vehicle 10. Based on determination that the object exterior the vehicle is projected to pass close to the opened window of the vehicle, the system determines a collision hazard and generates and alert and/or activates a safety measure. Based on determination that the vehicle is stationary, the method 900 includes at operation 906 determining if the detected body part is from a person inside the vehicle or a person exterior the vehicle. Based on determination that the body part is from a person interior the vehicle and extending through or near the opened window, the method 900 includes at operation 908 determining if a hazardous object like a vehicle is approaching the side of the vehicle at which the body part is extending through the window. Based on determination that the hazardous object is approaching the body part extending through the window, the system determines a collision hazard and generates an alert and/or activates a safety measure. Based on determination that the body part is from a person exterior the vehicle and extending through or near the opened window, the method 900 includes at operation 910 determining whether the window 11 is being raised or moved toward the closed position. Based on determination that the window 11 is being closed, the system determines an autoclose hazard and prevents closing of the opened window.

Thus, the cabin monitoring system processes sensor data representative of the interior cabin of the vehicle (e.g., from the DMS/OMS camera, a radar sensor, a beam break sensor, and the like) to determine position of a body part of a vehicle occupant relative to an opened window of the vehicle. The system may determine the position of the body part relative to the opened window based on body part identification (e.g., via the neural network) and tracking the position of the body part within the interior cabin. The system may determine that the body part is in a potentially hazardous position (e.g., close to the opened window and/or extending at least partially through the opened window) based on the tracked position of the body part and/or the beam break sensor being triggered. Further, the cabin monitoring system processes sensor data representative of regions exterior of the vehicle (e.g., from one or more exterior viewing cameras, radar sensors, ultrasonic sensors, and the like) to detect objects near the vehicle and to determine positions and projected trajectories of the detected objects relative to the opened window. Based on determination that the detected object may pass near to the opened window and/or based on determination that the detected object may pass near and/or contact the body part of the vehicle occupant, the system may generate an alert and/or move the window toward the closed position. Further, with the vehicle stationary the system may determine that a body part of a person exterior the vehicle extends through the opened window. Based on determination that the window is being moved toward the closed position, the system may stop movement of the window and/or deactivate an autoclose feature of the window to prevent the window from closing on the body part. The system may utilize characteristics of the systems described in U.S. Pat. Pub. No. US- 2025-0340203, which is hereby incorporated herein by reference in its entirety.

The camera or sensor may comprise any suitable camera or sensor. Optionally, the camera may comprise a "smart camera" that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640 x 480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014- 0347486; US-2014-0320658; US-2014-0336876; US-2014-0307095; US-2014-0327774; US-2014-0327772; US-2014-0320636; US-2014-0293057; US-2014-0309884; US-2014- 0226012; US-2014-0293042; US-2014-0218535; US-2014-0218535; US-2014-0247354; US-2014-0247355; US-2014-0247352; US-2014-0232869; US-2014-0211009; US-2014- 0160276; US-2014-0168437; US-2014-0168415; US-2014-0160291; US-2014-0152825; US-2014-0139676; US-2014-0138140; US-2014-0104426; US-2014-0098229; US-2014- 0085472; US-2014-0067206; US-2014-0049646; US-2014-0052340; US-2014-0025240; US-2014-0028852; US-2014-005907; US-2013-0314503; US-2013-0298866; US-2013- 0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US- 2017-0356994; US-2017-0315231; US-2017-0276788; US-2017-0254873; US-2017- 0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward / rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022- 0377219; US-2022-0254132; US-2022-0242438; US-2021-0323473; US-2021-0291739; US-2020-0320320; US-2020-0202151; US-2020-0143560; US-2019-0210615; US-2018- 0231976; US-2018-0222414; US-2017-0274906; US-2017-0217367; US-2016-0209647; US-2016-0137126; US-2015-0352953; US-2015-0296135; US-2015-0294169; US-2015- 0232030; US-2015-0092042; US-2015-0022664; US-2015-0015710; US-2015-0009010 and/or US-2014-0336876, and/or International Publication Nos. WO 2023/220222 and/or WO 2025/231198 and/or International Patent Application Ser. No. PCT/US25/038021, filed Jul. 17, 2025 (Attorney Docket DON01 FP5398W0), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. No. 11,242,008; 10,442,360 and/or 10,046,706, and/or U.S. Publication Nos. US-2024- 0064274; US-2021-0245662; US-2021-0162926; US-2021-0155167 and/or US-2019- 0118717, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:an interior sensor disposed at an interior portion of an interior cabin of a vehicle, wherein the interior sensor senses within the interior cabin of the vehicle;an exterior sensor disposed at the vehicle, wherein the exterior sensor senses exterior of the vehicle;an electronic control unit (ECU);wherein sensor data captured by the interior sensor is transferred to the ECU and sensor data captured by the exterior sensor is transferred to the ECU;wherein the ECU comprises electronic circuitry and associated software, and
wherein the electronic circuitry of the ECU comprises a processor operable to process sensor data transferred to the ECU;
wherein, via processing at the ECU of sensor data captured by the interior sensor, the vehicular cabin monitoring system detects a body part of an occupant of the vehicle proximate an opened window of the vehicle;
wherein, responsive to detection of the body part of the occupant proximate the opened window of the vehicle, and via processing at the ECU of sensor data captured by the exterior sensor, the vehicular cabin monitoring system determines that an object exterior the vehicle is hazardous to the body part of the occupant proximate the opened window of the vehicle; and
wherein, responsive to determination that the object exterior the vehicle is hazardous to the body part of the occupant proximate the opened window of the vehicle, the vehicular cabin monitoring system at least one selected from the group consisting of (i) generates an alert to the occupant of the vehicle and (ii) controls movement of the window toward a closed position.

2. The vehicular cabin monitoring system of claim 1, wherein the interior sensor comprises a camera.

3. The vehicular cabin monitoring system of claim 2, wherein the camera is accommodated by a mirror head of an interior rearview mirror assembly of the vehicle, and wherein the mirror head accommodates a mirror reflective element, and wherein the camera and the mirror reflective element move together and in tandem with the mirror head when, with the interior rearview mirror assembly mounted at the interior portion of the interior cabin of the vehicle, the mirror head is adjusted about mounting structure to provide a rearward view for a driver of the vehicle provided by the mirror reflective element.

4. The vehicular cabin monitoring system of claim 1, wherein the interior sensor comprises a radar sensor.

5. The vehicular cabin monitoring system of claim 1, wherein the interior sensor comprises a break beam sensor comprising (i) a light beam emitter configured to emit a beam of light across a window opening of the vehicle and (ii) a beam receiver configured to receive the emitted beam of light, and wherein the vehicular cabin monitoring system detects the body part of the occupant of the vehicle proximate the opened window of the vehicle based on the body part interrupting the beam of light between the light beam emitter and the beam receiver.

6. The vehicular cabin monitoring system of claim 5, wherein the light beam emitter emits one selected from the group consisting of (i) infrared light and (ii) near infrared light.

7. The vehicular cabin monitoring system of claim 1, wherein the exterior sensor comprises a camera.

8. The vehicular cabin monitoring system of claim 1, wherein the exterior sensor comprises a radar sensor.

9. The vehicular cabin monitoring system of claim 1, wherein the exterior sensor comprises an ultrasonic sensor.

10. The vehicular cabin monitoring system of claim 1, wherein the vehicular cabin monitoring system determines that the object exterior the vehicle is hazardous to the body part of the occupant proximate the opened window of the vehicle based on determination that a projected trajectory of the object intersects a determined position of the body part.

11. The vehicular cabin monitoring system of claim 1, wherein, responsive to determination that the object exterior the vehicle is hazardous to the body part of the occupant proximate the opened window of the vehicle, the vehicular cabin monitoring system generates the alert to the occupant of the vehicle, and wherein the alert comprises at least one selected from the group consisting of (i) an audible alert and (ii) a visual alert.

12. The vehicular cabin monitoring system of claim 1, wherein, responsive to determination that the object exterior the vehicle is hazardous to the body part of the occupant proximate the opened window of the vehicle, the vehicular cabin monitoring system controls movement of the window toward the closed position, and wherein, as the window moves toward the closed position, the vehicular cabin monitoring system (i) monitors the body part of the occupant proximate the opened window of the vehicle via processing at the ECU of sensor data captured by the interior sensor and (ii) controls movement of the window to stop movement of the window toward the closed position prior to the body part being pinched by the window.

13. A vehicular cabin monitoring system, the vehicular cabin monitoring system comprising:
an interior rearview mirror assembly comprises a mirror head adjustable about a mounting structure, wherein the mounting structure is configured to mount the interior rearview mirror assembly at an interior portion of an interior cabin of a vehicle;
wherein the mirror head accommodates a mirror reflective element;
wherein a camera is accommodated by the mirror head, and wherein, with the interior rearview mirror assembly mounted at the interior portion of the interior cabin of the vehicle, the camera views within the interior cabin of the vehicle;
wherein the camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle;
an exterior sensor disposed at the vehicle, wherein the exterior sensor senses exterior of the vehicle;
an electronic control unit (ECU);
wherein image data captured by the camera is transferred to the ECU and sensor data captured by the exterior sensor is transferred to the ECU;
wherein the ECU comprises electronic circuitry and associated software, and wherein the electronic circuitry of the ECU comprises at least one data processor operable to process image data transferred to the ECU and sensor data transferred to the ECU;
wherein, via processing at the ECU of image data captured by the camera, the vehicular cabin monitoring system detects a body part of an occupant of the vehicle proximate an opened window of the vehicle;
wherein, responsive to detection of the body part of the occupant proximate the opened window of the vehicle, and via processing at the ECU of sensor data captured by the exterior sensor, the vehicular cabin monitoring system determines that an object exterior the vehicle is hazardous to the body part of the occupant proximate the opened window of the vehicle;
wherein, responsive to determination that the object exterior the vehicle is hazardous to the body part of the occupant proximate the opened window of the vehicle, the vehicular cabin monitoring system controls movement of the window toward a closed position; and
wherein, as the window moves toward the closed position, the vehicular cabin monitoring system (i) monitors the body part of the occupant proximate the opened window of the vehicle via processing at the ECU of image data captured by the camera and (ii) controls movement of the window to stop movement of the window toward the closed position prior to the body part being pinched by the window.

14. The vehicular cabin monitoring system of claim 13, wherein the exterior sensor comprises a camera.

15. The vehicular cabin monitoring system of claim 13, wherein the exterior sensor comprises a radar sensor.

16. The vehicular cabin monitoring system of claim 13, wherein the exterior sensor comprises an ultrasonic sensor.

17. The vehicular cabin monitoring system of claim 13, wherein the vehicular cabin monitoring system determines that the object exterior the vehicle is hazardous to the body part of the occupant proximate the opened window of the vehicle based on determination that a projected trajectory of the object intersects a determined position of the body part.

18. The vehicular cabin monitoring system of claim 13, wherein, responsive to determination that the object exterior the vehicle is hazardous to the body part of the occupant proximate the opened window of the vehicle, the vehicular cabin monitoring system generates an alert to the occupant of the vehicle, and wherein the alert comprises at least one selected from the group consisting of (i) an audible alert and (ii) a visual alert.

19. A vehicular cabin monitoring system, the vehicular cabin monitoring system comprising:
a radar sensor disposed at an interior portion of an interior cabin of a vehicle, wherein the radar sensor senses within the interior cabin of the vehicle;
an exterior sensor disposed at the vehicle, wherein the exterior sensor senses exterior of the vehicle;
an electronic control unit (ECU);
wherein radar data captured by the radar sensor is transferred to the ECU and sensor data captured by the exterior sensor is transferred to the ECU;
wherein the ECU comprises electronic circuitry and associated software, and wherein the electronic circuitry of the ECU comprises at least one data processor operable to process radar data transferred to the ECU and sensor data transferred to the ECU;
wherein, via processing at the ECU of radar data captured by the radar sensor, the vehicular cabin monitoring system detects a body part of an occupant of the vehicle proximate an opened window of the vehicle;
wherein, responsive to detection of the body part of the occupant proximate the opened window of the vehicle, and via processing at the ECU of sensor data captured by the exterior sensor, the vehicular cabin monitoring system determines that an object exterior the vehicle is hazardous to the body part of the occupant proximate the opened window of the vehicle; and
wherein, responsive to determination that the object exterior the vehicle is hazardous to the body part of the occupant proximate the opened window of the vehicle, the vehicular cabin monitoring system generates an alert to the occupant of the vehicle, and wherein the alert comprises at least one selected from the group consisting of (i) an audible alert and (ii) a visual alert.

20. The vehicular cabin monitoring system of claim 19, wherein the exterior sensor comprises at least one selected from the group consisting of (i) a camera, (ii) a radar sensor and (iii) an ultrasonic sensor.
